(19) United States
(12) Patent Application Publication
(10) Pub. No.: US 2021/0122180 A1
(43) Pub. Date: Apr. 29, 2021

(54) INFORMATION HOLDING ARTICLE

(71) Applicant: SCANAVO A/S, Taastrup (DK)

(72) Inventors: Karsten NORMANN, Taastrup (DK); Jeanette SØLLING, Taastrup (DK)

(73) Assignee: SCANAVO A/S, Taastrup (DK)

(21) Appl. No.: 17/041,744

(22) PCT Filed: Mar. 20, 2019
(86) PCT No.: PCT/DK2019/050096

§ 371 Date: Sep. 25, 2020

(30) Foreign Application Priority Data
Mar. 26, 2018 (DK) PA201870186

(51) Int. Cl. B42D 3/02; B42F 13/00

(52) U.S. Cl. CPC B42D 3/02; B42F 13/0013

(57) ABSTRACT

An information holding article including an inner part and an outer part, where the inner part includes a number of pages adapted for holding printed information, where the outer part includes a plastic cover with a first and a second side element and a back element provided between the first and the second side element and being adapted for mutual pivotal movement between the back element and the first and/or the second side element. The inner part is connected to the plastic cover at one of the first side element, the second side element or the back element, where the two side elements are spaced apart when the inner part is connected to the plastic cover and where the inner part is adapted to fit a certain width of the back element by including a thickness correcting element to the inner part.

### FIELD OF THE INVENTION

The present invention relates to the area of information holding articles, which counts numerous variations.

### BACKGROUND OF THE INVENTION

Among the many variations within the field of information holding articles there are a couple that should be mentioned in this context.

The traditional book comprising a cover and a number of content pages is very well-known.

Plastic boxes where a printed inlay is loosely placed inside the box, often together with other items, is likewise a well-known solution.

GB 2249859 discloses a media packaging where on the outside a number of leaves are placed for containing and displaying various information or artwork. Commonly known problems related to these information holding articles are the need to individualize the cover for the book in order to achieve the right dimensions and the ability to maintain the sides of the cover essentially parallel when the book is closed or have the inlay loosely placed in the cover.

### Objective of the Invention

The object of the present invention is to therefore provide for an information holding article that may be manufactured in a standard size and being adapted for variations in the content and hence reduce the effort of individualising the information holding article.

### DESCRIPTION OF THE INVENTION

According to one aspect of the present invention the objective of the invention is achieved through an information holding article comprising an inner part and an outer part, where the inner part comprises a number of pages adapted for holding printed information and optionally comprises one or more parts for holding an information carrying medium or an object, where the outer part comprises a plastic cover with a first and a second side element and where a back element is provided between the first and the second side element an being adapted for mutual pivotal movement between the back element and the first and/or the second side element, where the inner part is connected to the plastic cover at one of the first side element, the second side element or the back element, where the two side elements are spaced apart when the inner part is connected to the plastic cover, where the pages of the inner part has a thickness less than the width of the back element, and where the inner part is adapted to fit a the width of the back element by including, together with the pages, a thickness correcting element to the inner part

Hereby it is possible to individualize the cover part with individual art work for different purposes and for different embodiments, as the inner part is adapted to fit the width of the back element by including a thickness correcting element.

In an embodiment, the thickness correcting element is positioned after the pages comprising printed information.

In a further embodiment, the thickness correcting element is positioned after the pages comprising printed information and prior to possible media or object holding part.

In an embodiment, a metal cover part is connected to each of the plastic cover first side element, the plastic cover second side element and further to the back element, where the two side elements with the connected metal cover parts are spaced apart when the inner part is connected to the plastic cover.

According to another aspect of the invention the objective of the present invention is achieved through an inner part for use in an information holding article or an object according to any of the preceding claims, where the inner part is adapted to fit the width of the back element by including a thickness correcting element to the inner part.

Hereby a thickness correcting element may be positioned after the pages comprising printed information.

In another embodiment the thickness correcting element is positioned after the pages comprising printed information and prior to possible media or object holding part.

### BRIEF DESCRIPTION OF THE DRAWINGS

The invention will in the following be described with reference to one embodiment illustrated in the drawings where:

FIG. 1A, 1B shows a perspective view of an information holding article according to the invention;

FIG. 2A, 2B shows a back and opening side view of an information holding article according to the invention;

FIG. 3 shows an open folded view of an information holding article according to the invention;

FIG. 4A, 4B, 4C shows open folded views of an information holding article according to the invention;

FIG. 5A, 5B, 5C, 5D, 5E shows back, front side, opening side and top views of an information holding article according to the invention;

FIG. 6A, 6B, 6C, 6D shows front and rear side views of a cover element of an information holding article according to the invention;

FIG. 7 shows a bottom view of an outer part with an inner part constituting an information holding article according to the invention;

FIG. 8 is a schematic perspective view of an inner part of an information holding article;

FIG. 9 is a schematic drawing showing an end view of a first embodiment of an inner part;

FIG. 10 is a schematic drawing showing an end view of a second embodiment of an inner part;

FIG. 11 is a schematic drawing showing an end view of a third embodiment of an inner part;

FIG. 12 is a schematic drawing showing an end view of a fourth embodiment of an inner part.

### DESCRIPTION OF AN EMBODIMENT

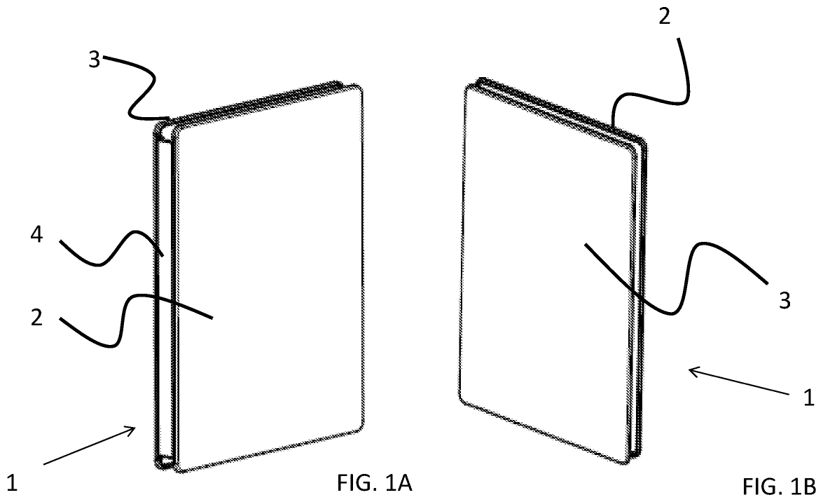

From FIG. 1 perspective views of the information holding article 1 according to the invention appears. The information holding article comprises a front part 2, a rear part 3 and a back part 4 connecting the front and the rear parts 2,3 through flexible hinge connections.

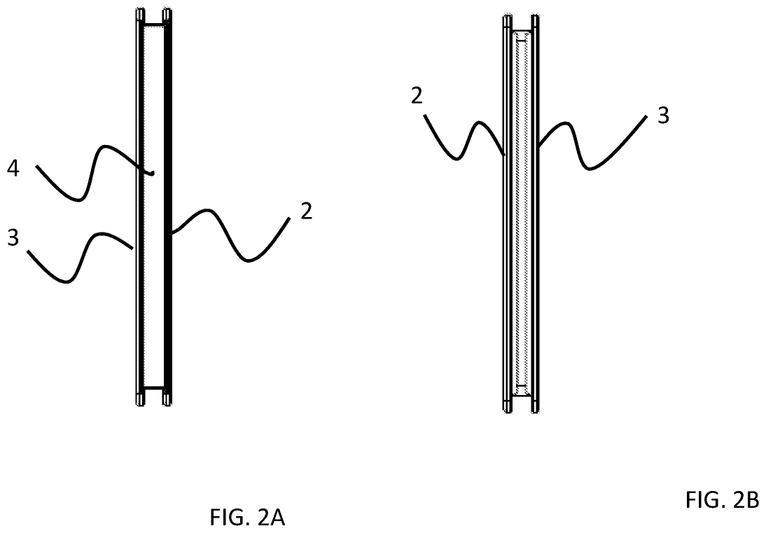

From FIG. 2 the information holding article appears seen from the back and the opening side. The front and the rear elements 2,3 as well as the back element 4 appears from this schematic.

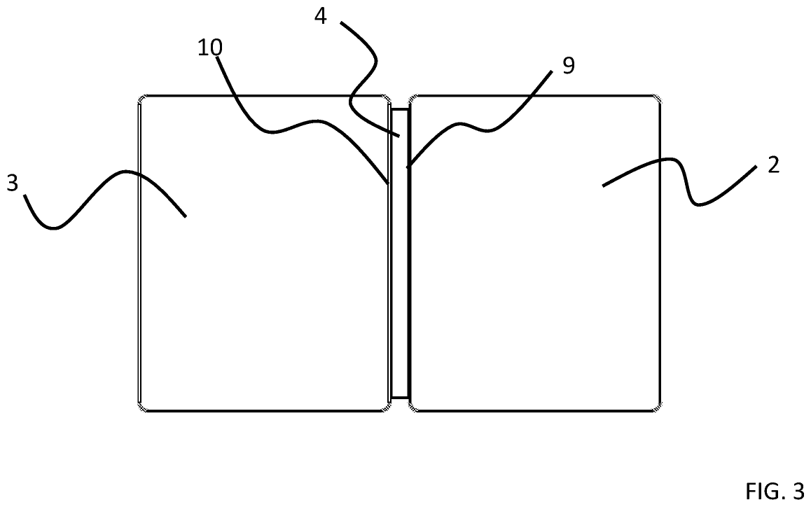

From FIG. 3 the information holding article appears in a view where the front and rear elements 2,3 are folded at the hinge connections 9,10 to the back element 4, from their closed position to a wide open position, which would represent a normal position for use, e.g. for reading.

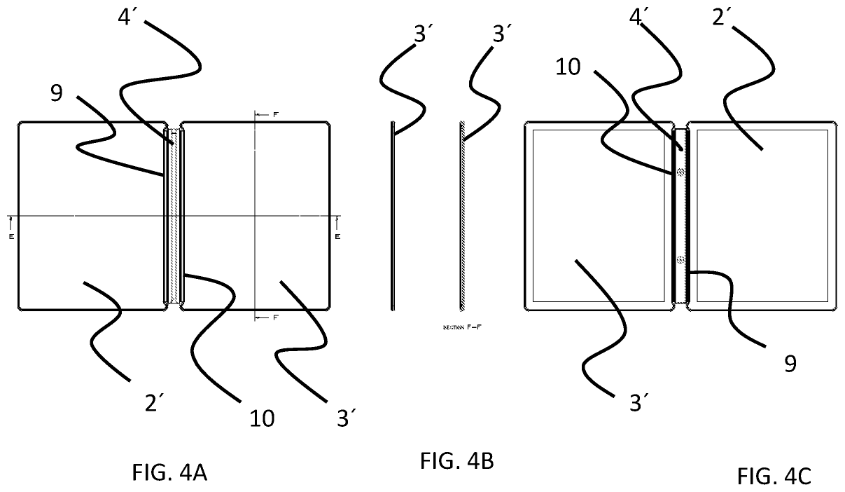

The cover part or the outer part will typically comprises an inner carrier part 2′,3′,4′ as well as outer art parts 2″,3″4″. From FIG. 4 the inner carrier part of an information holding article according to the invention appears in an open folded position. The front and rear side elements 2′,3′ are folded relative to the back element 4′ at the flexible hinges 9,10 connecting the front side and the rear side elements 2′,3′ to the back element 4′. FIG. 4A shows and inside view of the carrier part, FIG. 4B shows side views and sectional views of the open folded carrier part and FIG. 4C shows an outside view of the open folded carrier part.

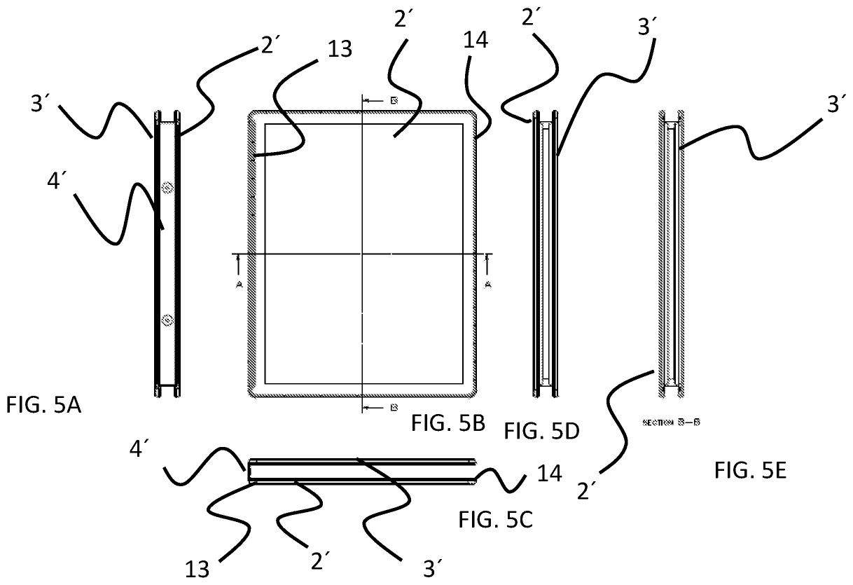

From FIG. 5 the inner part of the cover appears in different views. The inner carrier part of the cover is typically a plastic element made in a single piece having hinge elements 9,10 formed between the front side element 2′ and the back element 4′ and further between the rear side element 3′ and the back element 4′. It appears that the side elements in a closed position are essentially parallel to each other. FIG. 5a shows a back side view, FIG. 5B a front side view, FIG. 5C a top view, FIG. 5D an opening side view and FIG. 5E an opening side view along the section B-B in FIG. 5B.

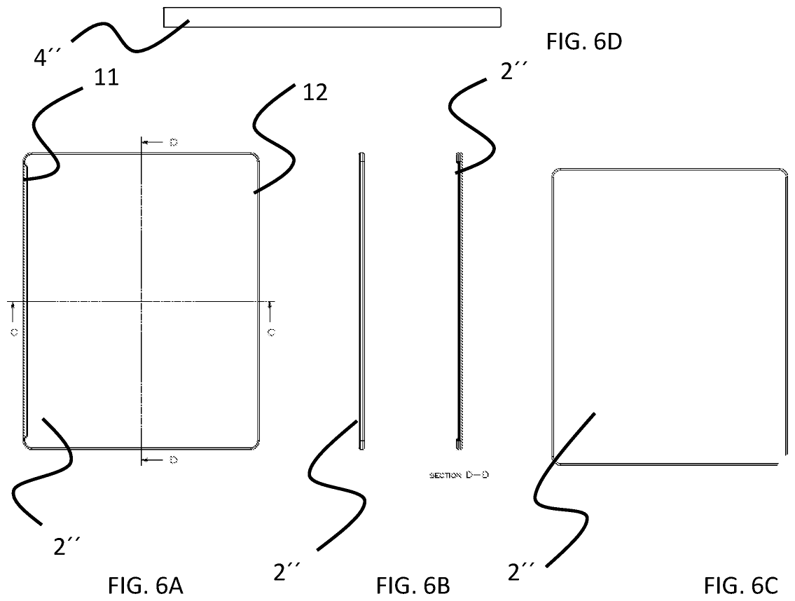

From FIG. 6 the metal cover parts adapted to be attached to the plastic inner carrier part of the cover appears. The metal cover parts comprise at least at two opposed edges 11,12 folded parts adapted to engage with the plastic inner carrier part of the cover. The metal cover will typically be a part carrying art work, which may be printed art work, embossments or similar to provide a particular attractive appearance of the information holding article. The separate engagement of the metal cover parts further allows for an individualization of the information holding article with a limited effort. FIG. 6A shows the metal cover part seen from the inside that will face the plastic carrier part in a mounted state. FIG. 6B shows the metal cover part in a side view and a sectional view and FIG. 6C shows the metal cover part in an outside view that will represent the outside of the information holding article and normally carry any artwork to be presented. FIG. 6D shows the metal cover part 4″, the spine, which will typically cover the back of the plastic carrier part.

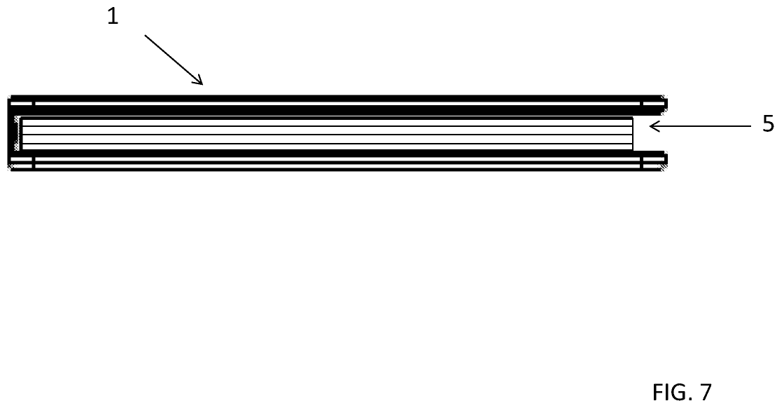

From FIG. 7 a bottom view of a cover part and an inner part appears. The cover part corresponds to the embodiment scribed in connection with the previous figures. The inner part may appear in a number of variations, which will become apparent in connection with the description of the following figures.

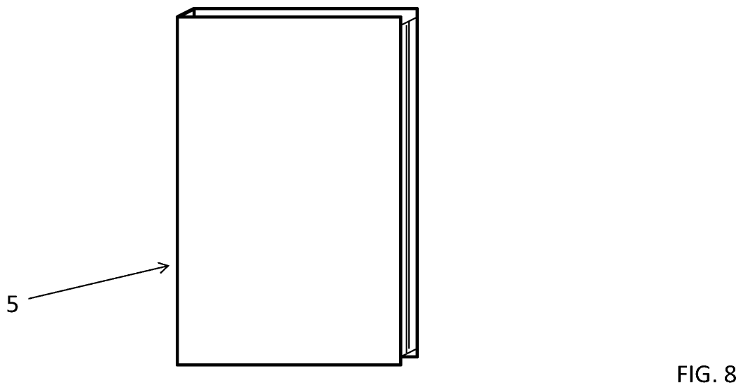

From FIG. 8 a perspective view of an inner part 5 of an information holding article appears.

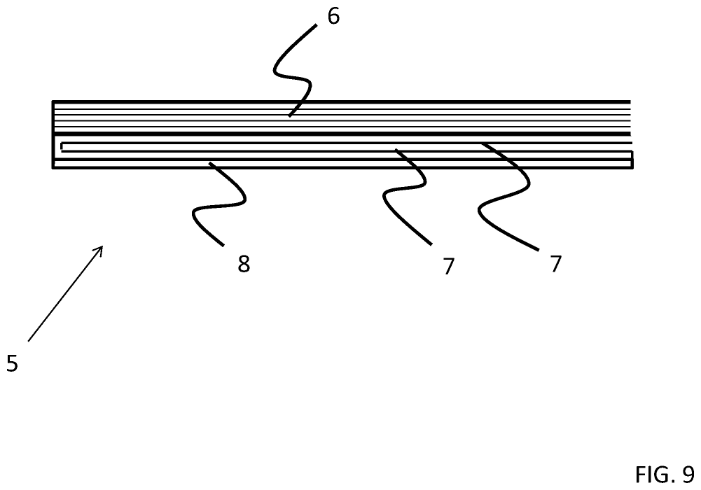

From FIGS. 9-12 different versions of the inner part appears as seen from the bottom side. The various information holding elements of the inner part have different thicknesses and hence would normally require a cover or outer part corresponding to this. However due to the fact that a thickness correcting element is provided for correcting the total thickness to be similar for the various embodiments of the inner part it is possible to use the same outer cover for all versions/embodiments and hence provide for a more rational production of different information holding articles independent of the actual amount of information provided in these and still maintain a desired essentially parallel appearance of the side elements of the cover when the information holding article is closed.

FIG. 9 shows an embodiment with a first number of printed pages 6 which are connected to a thickness correcting element 8 at a first side of this and where at a second side of the thickness correcting element opposite the first side is connected to media holding parts, in this case two media holding parts in serial connection.

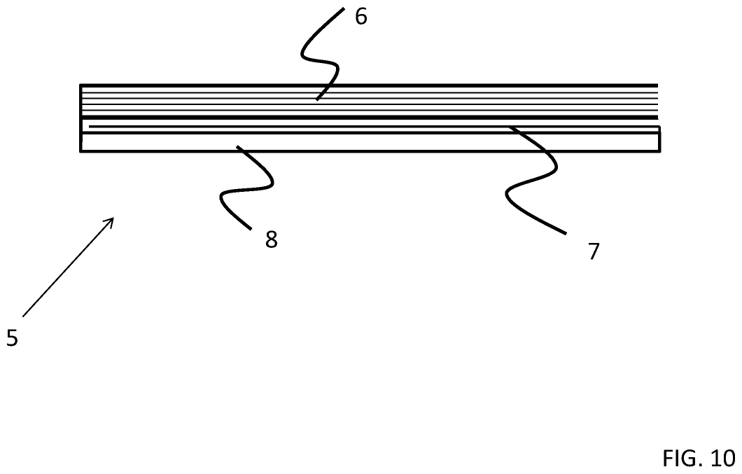

FIG. 10 shows an embodiment with a first number of printed pages 6 which are connected to a thickness correcting element 8 at a first side of this and where at a second side of the thickness correcting element opposite the first side is connected to a single media holding parts. The difference compared to the embodiment shown in FIG. 9 is that the thickness correcting element 8 is somewhat thicker in order to compensate for lack of the second media holding part.

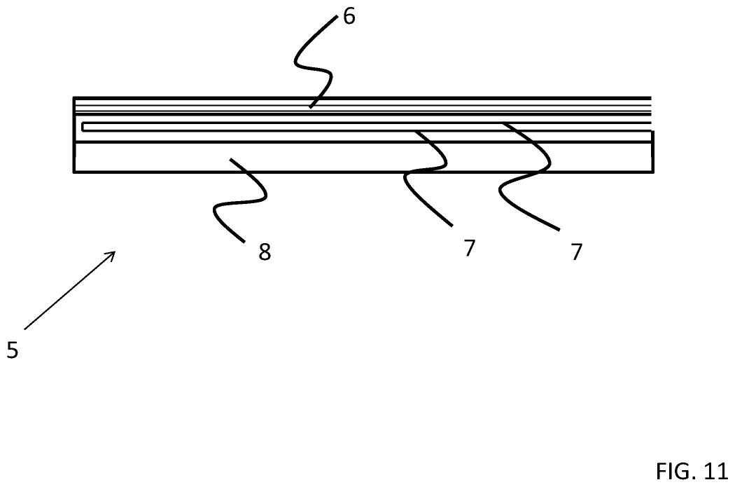

FIG. 11 shows an embodiment with a first number of printed pages 6 which are connected to a thickness correcting element 8 at a first side of this and where at a second side of the thickness correcting element opposite the first side is connected to media holding parts, in this case two media holding parts in serial connection. The difference compared to the embodiment shown in FIG. 9 is that a smaller number of pages is present and hence the thickness of this part is reduced. In order to compensate for this the thickness correcting element need to have a corresponding increased thickness.

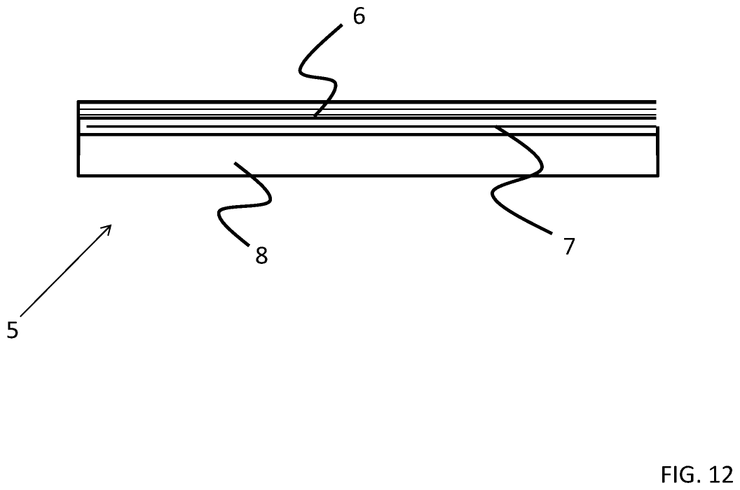

FIG. 12 shows an embodiment with a first number of printed pages 6 which are connected to a thickness correcting element 8 at a first side of this and where at a second side of the thickness correcting element opposite the first side is connected to a single media holding parts. Further the number of printed pages is smaller compared to the embodiment shown in FIG. 9. In order to compensate for the lack of the second media holding part and the reduced number of pages the thickness correcting element 8 is made correspondingly thicker.

The thickness of the inner part may be expressed in the following manner:

T=x+y+z

where

T is the total thickness of the inner part;

x is the thickness of the printed pages;

y is the thickness of the media holders, incl. media;

and

z is the thickness of the thickness correcting element.

In order to maintain a uniform thickness of the inner part the thickness of the thickness correcting part may be varied for different inner parts where e.g. the number of printed pages vary or where the number of media holders vary, and hence a standard size outer part or cover may be used for several different versions of the inner part.

1. An information holding article comprising:
an inner part comprising a number of pages adapted for holding printed information
an outer part comprising a plastic cover, the plastic cover comprising:
a first side element
a second side element; and
a back element provided between the first side element and the second side element and adapted for mutual pivotal movement between the back element and the first side element and/or the second side element, wherein the inner part is connected to the plastic cover at the first side element, wherein the first side element and the second two side element are spaced apart when the inner part is connected to the plastic cover;
wherein the pages of the inner part have a combined thickness less than a width of the back element; and
wherein the inner part is adapted to fit the width of the back element by the inner part comprising, together with the pages, a thickness correcting element.

2. The information holding article according to claim 1, wherein the thickness correcting element is positioned after the pages adapted for holding the printed information.

3. (canceled)

4. The information holding article according to claim 1, wherein a metal cover part is connected to each of the first side element, the second side element, and the back element, where the first side element and the second side element with their correspondingly connected metal cover parts are spaced apart when the inner part is connected to the plastic cover.

5. An inner part comprising:
a number of pages, for use in an information holding article comprising:
an outer part comprising a plastic cover, the plastic cover comprising:
a first side element;
a second side element; and
a back element provided between the first side element and the second side element and adapted for mutual pivotal movement between the back element and the first side element and/or the second side element, wherein the inner part is connected to the plastic cover at the first side element, wherein the first side element and the second side element are spaced apart when the inner part is connected to the plastic cover;
wherein the pages of the inner part have a combined thickness less than a width of the back element; and
wherein the inner part is adapted to fit the width of the back element by the inner part comprising, together with the pages, a thickness correcting element.

6. The inner part according to claim 5, wherein the thickness correcting element is positioned after the pages, wherein the pages are adapted for holding printed information.

7. The inner part according to claim 5, wherein the thickness correcting element is positioned after the pages, wherein the pages are adapted for holding printed information and prior to a possible media or object holding part.

8. The information holding article according to claim 7, wherein the inner part comprises a part for holding an object, wherein the thickness correcting element is positioned after the pages adapted for holding the printed information and prior to the part for holding the object.

9. The information holding article according to claim 8, wherein the object is an information carrying medium.
